(19) United States
(12) Patent Application Publication
(10) Pub. No.: US 2010/0059083 A1
(43) Pub. Date: Mar. 11, 2010

(54) Reticle Cleaning Device

(76) Inventor: Pen-Wei TSOU, Shulin City (TW)

Correspondence Address: SINORICA, LLC, 2275 Research Blvd., Suite 500, ROCKVILLE, MD, 20850, US

(21) Appl. No.: 12/241,334

(22) Filed: Sep. 30, 2008

(30) Foreign Application Priority Data
Sep. 9, 2008 (TW) 097134525

(51) Int. Cl. B08B 7/00; B08B 13/00

(52) U.S. Cl. 134/1; 134/115 R; 134/56 R

(57) ABSTRACT

A reticle cleaning device, comprising: a chamber body having a sealed chamber, within which is a reticle stage for carrying a reticle, wherein a frame attached with a protective membrane is included on the reticle; an optical component, for transmitting a light beam to the protective membrane on the reticle and receiving light beam reflected from the protective membrane and outputting a signal to indicate the upward and downward expansion change of protective membrane on the reticle; a pump, for exhausting the air inside the sealed chamber of chamber body to form negative pressure in the sealed chamber for separating contaminants or chemical contaminants on the reticle; and a controller, for receiving the signal from the optical component, wherein when the upward and downward expansion change of the protective membrane on the reticle indicated by the signal exceeds a pre-set value, the controller outputs another signal to terminate the operation of the pump.

### BACKGROUND OF THE INVENTION

1. Field of the Invention

The present field of the invention is related to a reticle cleaning device and its cleaning method, and more particularly, to a cleaning device that cleans reticle by vacuum cleaning, wherein an optical component is used in the cleaning process to monitor the upward and downward expansion change of protective membrane on the reticle.

2. Description of the Prior Art

In semiconductor manufacturing process, microfilm equipment is usually used to form circuit pattern on reticle completely and precisely on photoresist on wafer and perform exposure. At the same time, some contaminants or particles that further contaminate the reticle will be generated. Therefore, during the cleaning process, remnant organic materials, contaminants, and chemical contaminants on the surface of reticle need to be effectively and thoroughly cleaned; otherwise contaminated reticle will lead to serious yield loss in the following manufacturing process.

Referring to FIG. 1, which is a view of reticle cleaning device of conventional prior art. In the reticle cleaning device 20, reticle R is fastened by a horizontal reticle fastener 220 disposed on rotation stage 210, and a movable cleaning nozzle 230 is used for producing forceful water flow or gas flow to impact on the surface of reticle. However, with this cleaning method, only the back side of reticle can be cleaned, since the front side of reticle includes a protective membrane that cannot bear the impact of this forceful water flow or gas flow.

Moreover, some cleaning devices also clean reticle with method of vacuum cleaning or air exhaustion. However, since the protective membrane on the reticle cracks easily during the process of forming vacuum, therefore at present there is still no such kind of product in the market.

### SUMMARY OF THE INVENTION

In order to avoid defects of the conventional prior art, one objective of the present invention is to provide a reticle cleaning device, which removes particles or contaminants or chemical contaminants on the surface of the reticle by using the method of air exhaustion to enhance the yield of semiconductor manufacturing process.

Another objective of the present invention is to provide a reticle cleaning device, which removes particles or contaminants or chemical contaminants on the surface of the reticle by using the method of alternatively applying positive pressure and negative pressure that is able to avoid direct impact on the reticle and the protective membrane on the reticle.

Still another objective of the present invention is to provide a reticle cleaning device with an optical component to monitor the upward and downward expansion change of protective membrane on the reticle for preventing the protective membrane from cracking during the process of cleaning.

Yet another objective of the present invention is to provide a reticle cleaning device that cleans the reticle by forming negative pressure in the sealed chamber in which reticle is located and monitoring the upward and downward expansion change of protective membrane on the reticle with optical component at the same time, wherein not only contaminants or chemical contaminants between the reticle and the protective membrane are removed, but cracking of the protective membrane is also prevented during the process of cleaning.

According to above objectives, the present invention first provides a reticle cleaning device, including a chamber body, an optical component, a pump, and a controller. The chamber body includes a sealed chamber, within which is disposed with a reticle stage for carrying a reticle. The optical component is used for transmitting a light beam to the protective membrane on the reticle and receiving light beam reflected from the protective membrane and for outputting a signal to indicate the upward and downward expansion change of protective membrane on the reticle. The pump is used for exhausting the air inside the sealed chamber of chamber body to form negative pressure in the sealed chamber for separating contaminants or chemical contaminants on the reticle. And the controller is used for receiving the signal from the optical component; wherein when the upward and downward expansion change of the protective membrane on the reticle indicated by the signal exceeds a pre-set value, the controller outputs another signal to terminate the operation of the pump.

The present invention then discloses a method for cleaning reticle, including: providing a reticle inside a chamber body, wherein the reticle is disposed with a protective membrane; providing an optical component that transmits a light beam to the protective membrane on the reticle and receives the light beam reflected from the protective membrane for monitoring the upward and downward expansion change of protective membrane on the reticle; exhausting the air inside the chamber body to form negative pressure in the chamber body for separating contaminants or chemical contaminants on the reticle; wherein when the optical component detects that the upward and downward expansion change of protective membrane on the reticle exceeds a pre-set value, the process of exhausting air inside the chamber body is terminated.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view of a reticle cleaning device of the conventional prior art;

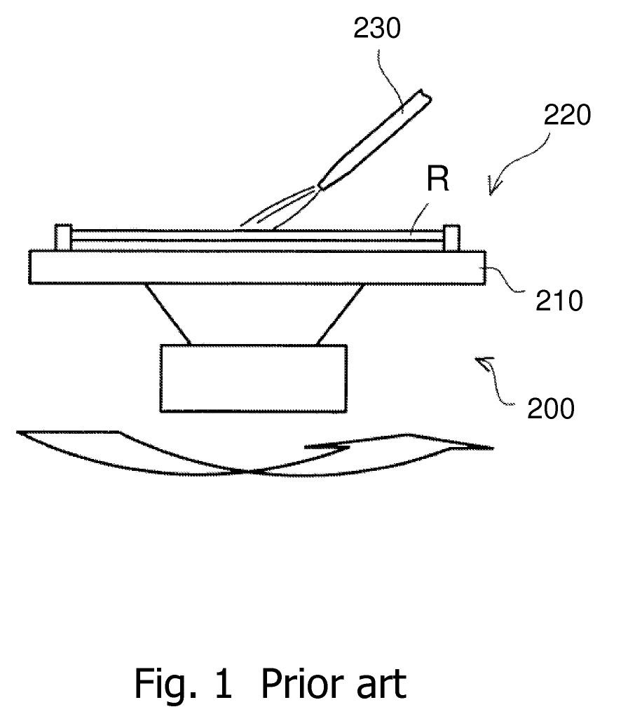

FIG. 2A is a front view of a reticle cleaning device of the present invention;

FIG. 2B is a side perspective view of a reticle cleaning device of the present invention;

FIG. 3A is a front view of the chamber body of a reticle cleaning device of the present invention;

FIG. 3B is a side view of the chamber body of a reticle cleaning device of the present invention;

FIG. 4 is a view of operation of the optical component of reticle cleaning device of the present invention; and

FIG. 5 is a flow diagram of reticle cleaning method of the present invention.

### DESCRIPTION OF THE PREFERRED EMBODIMENT

In order to disclose the skills applied in, the objectives of, and the effects achieved by the present invention in a more complete and clearer manner, preferred embodiments are herein described below in detail with related drawings disclosed for reference.

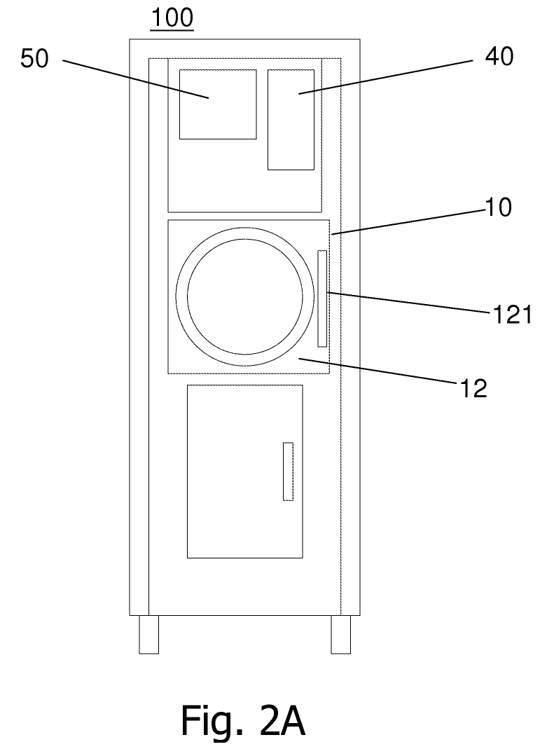

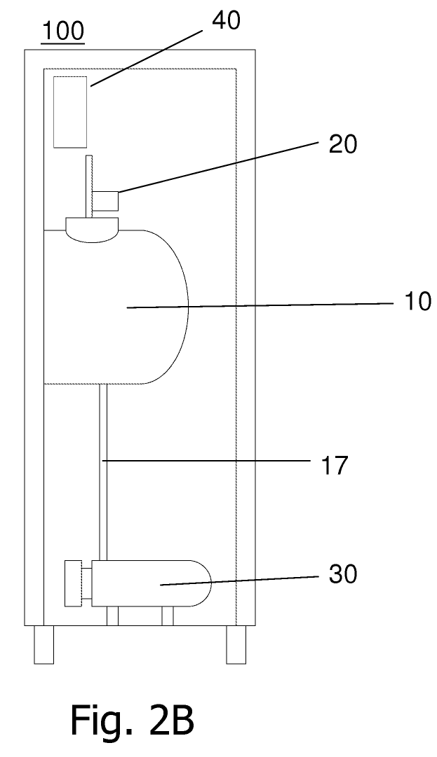

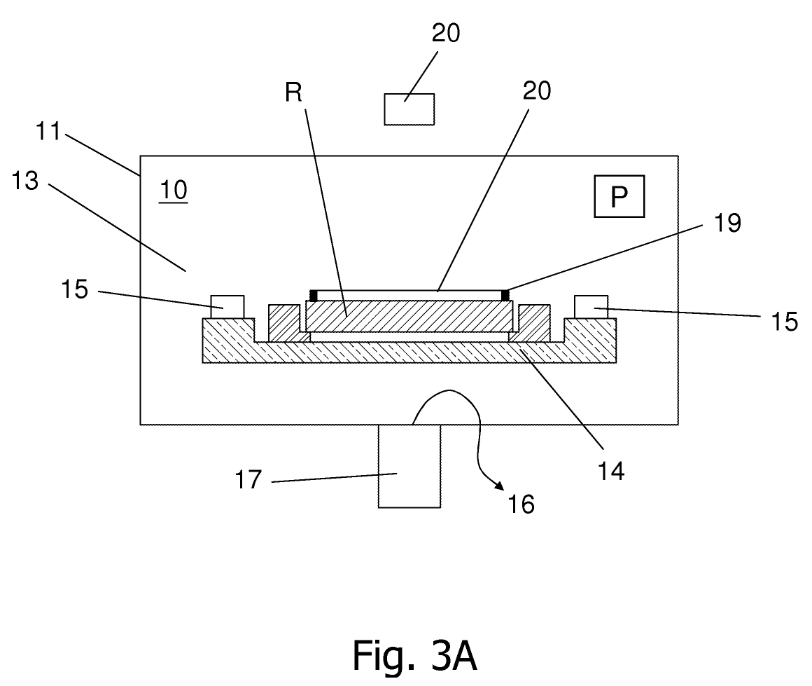

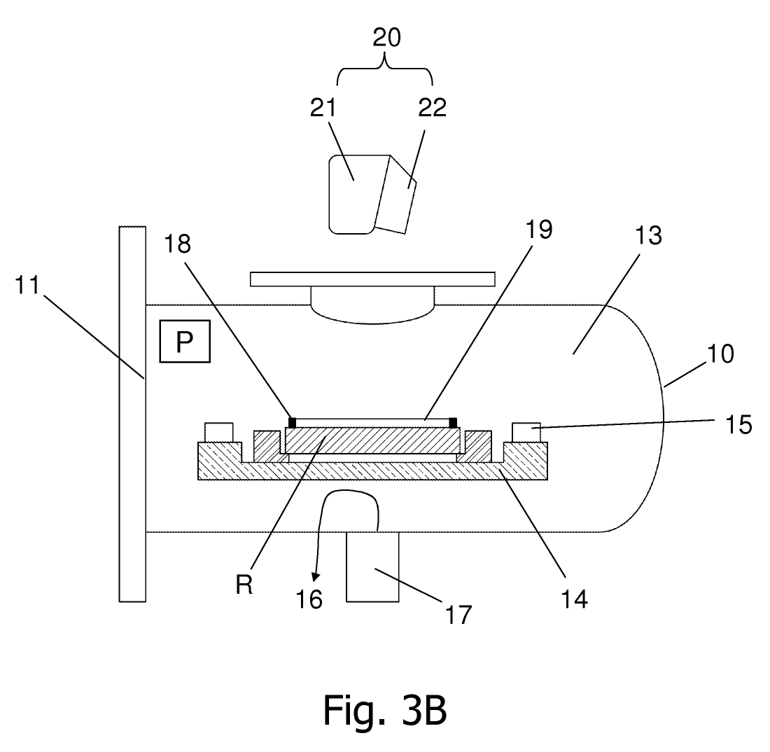

First, referring to FIG. 2A and FIG. 2B, which are a frontal view and a side perspective view of a reticle cleaning device of the present invention. And FIG. 3A and FIG. 3B are a front view and a side view of the chamber body of the aforementioned reticle cleaning device. The reticle cleaning device 100 of the present invention includes a chamber body 10, an optical component 20, a pump 30, and a controller 40. Wherein, the chamber body 10 includes an opening 11 and a chamber door 12 that is able to close the opening 11, and the chamber door 12 includes a handle 121 to facilitate the opening of chamber door 12. And inside the chamber body 10 is a sealed chamber body 13, in which is disposed with a reticle stage 14 for carrying a reticle R. A reticle detector 15 is also disposed around reticle R on the reticle stage 14 to detect whether reticle R is carried on the reticle stage 14 or whether reticle R is carried on the reticle stage 14 with the protective membrane facing upward. Meantime, a pressure detector P is included in the sealed chamber 13 to detect the degree of pressure in the sealed chamber 13.

Moreover, a gas inlet/outlet 16 is also included in the sealed chamber 13 of chamber body 10, and the gas inlet/outlet 16 is further disposed with a gas valve (not shown in Figure) that connects to the pump 30 of the cleaning device through a pipe 17. This pump 30 can exhaust air and contaminants or chemical contaminants in the sealed chamber 13 via the gas inlet/outlet 16 for the pressure inside the sealed chamber 13 to be lower than the atmospheric pressure, i.e. status of negative pressure. Of course, the pump 30 can also inject a gas through the same pipe 17 and gas inlet/outlet 16 into the sealed chamber 13 for the pressure inside the sealed chamber 13 to resume to the same as the atmospheric pressure to facilitate the process of opening chamber door 12 and exporting reticle R. And the gas described above can be a clean gas for diluting the contaminants or chemical contaminants in the sealed chamber 13; moreover, the amount of gas injected can also increase the pressure inside the sealed chamber 13 to be higher than the atmospheric pressure to achieve better cleaning effect.

And as shown in FIG. 2B, FIG. 3A, and FIG. 3B, the reticle cleaning device 100 of the present invention includes an optical component 20 located on top of the chamber body 10, which is composed of a light-transmitter 21 and a light-receiver 22, the light-transmitter 21 being used to transmit a light beam to a protective membrane 19 on top of reticle R on the reticle stage 14 and the light-receiver 22 being used to receive light beam reflected from the protective membrane 19. Since there will be upward and downward expansion change of protective membrane 19 on the reticle R when the pump 30 performs gas exhaustion or gas injection to the sealed chamber 13, the objective of disposing the optical component 20 is thus to monitor the upward and downward expansion change of protective membrane 19 in order to prevent excessive expansion of protective membrane 19 that leads to damage or crack. Therefore, when the optical component 20 detects that the upward and downward expansion change of protective membrane 19 exceeds a pre-set value (for example, 1 mm or 3 mm or 4 mm), the optical component 20 transmits an electric signal to a controller 40, a programmable logic controller (PLC) for example, for the controller 40 (as shown in FIG. 2A and FIG. 2B) to transmit another electric signal to terminate the exhaustion or injection process of the pump 30. And the light beam transmitted by the aforementioned light-transmitter 21 can be a laser light, a visible light, or an infrared light; correspondingly, the light-receiver 22 can also receive light beams of these specific wavelengths. And as shown in FIG. 3A and FIG. 3B, the protective membrane 19 is fixed on the reticle R mainly through a hollow frame 18 on top of reticle R, and the frame 18 includes at least a hole (not shown in Figure). Therefore, when the pump 30 described above performs gas exhaustion to the sealed chamber 13, it not only removes the contaminants or chemical contaminants on top of the protective membrane 19, but also carries contaminants or chemical contaminants between the protective membrane 19 and the reticle R away from the sealed chamber 13 through the hole on the frame 18.

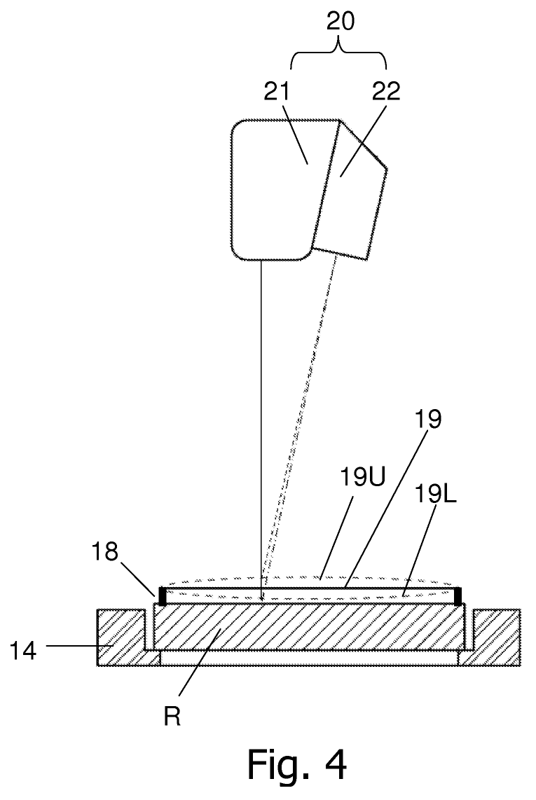

Then, referring to FIG. 4, which is a view of the operation of optical component 20 of the reticle cleaning device 100 of the present invention monitoring the protective membrane 19 on the reticle R. First, when the reticle R is placed inside the chamber body 10 or the sealed chamber 13 and the chamber door 12 is closed, the pressure in the sealed chamber 13 is equivalent to the pressure outside the chamber body 10 at the time, about an atmospheric pressure. Meantime, the protective membrane 19 is smoothly attached on the frame 18 on top of reticle R and the light beam transmitted by the light-transmitter 21 and light beam reflected from the protective membrane 19 form a pre-set included angle. When the pump 30 starts to exhaust air from the sealed chamber 13, the pressure in the sealed chamber 13 also starts to decrease, which further leads the protective membrane 19 to expand, the expansion being particularly obvious near the central area of the protective membrane 19. At this time the protective membrane 19U is in the status of upward expansion or upward protrusion, which also leads to a larger included angle between light beam transmitted by the light-transmitter 21 and the light beam reflected from the protective membrane 19 as the position where the light-receiver 22 receives the reflected light beam changes. And when the pump 30 starts to inject air into the sealed chamber 13 and the pressure in the sealed chamber 13 is increased to be higher than an atmospheric pressure, the aforementioned protective membrane 19 sinks downward to a position lower than the initial position. At this time the protective membrane 19L is in the status of downward expansion or downward concavity, and therefore the included angle between light beam transmitted by the light-transmitter 21 and light beam reflected from the protective membrane 19 becomes smaller, as the position where the light-receiver 22 receives the reflected light beam changes again. Due to that the light-receiver 22 is a plurality of photosensing components, thus with different positions of photosensing components receiving the reflected light beam, change in upward and downward expansion of protective membrane 19 on the reticle R or the frame 18 can be computed.

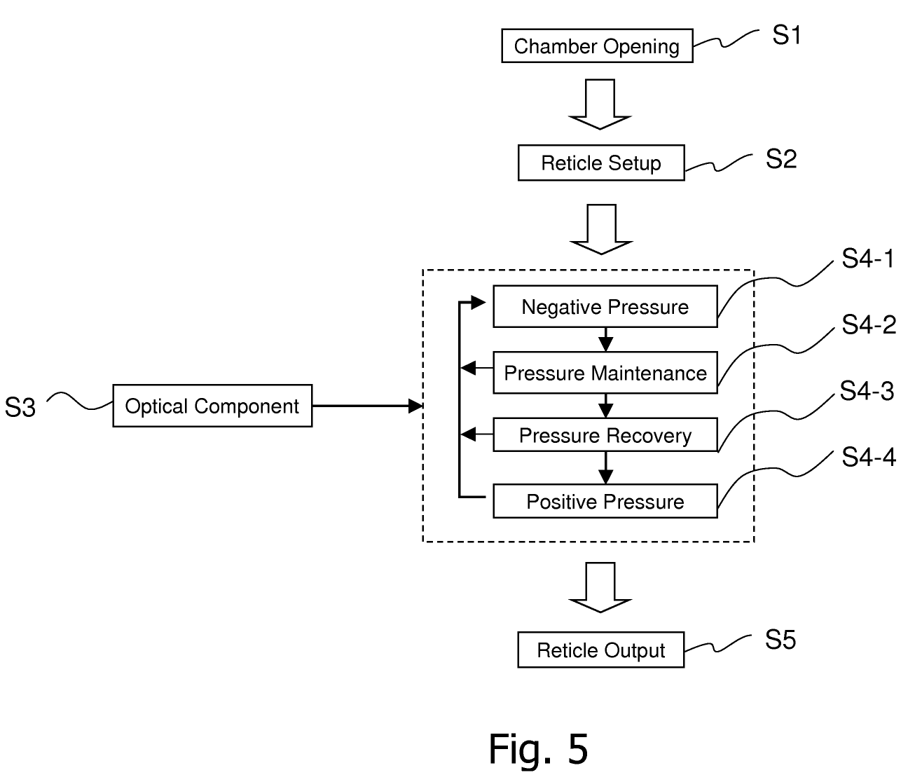

Moreover, as shown in FIG. 5, the present invention can also be embodied in a method for cleaning reticle, including: opening the chamber door 12 of reticle cleaning device 100 (step S1); providing a reticle R inside the chamber body 10 for the reticle R to be fixed on the reticle stage 14 (step S2); providing an optical component 20 to transmit a light beam to the protective membrane 19 on the reticle R and to receive light beam reflected from the protective membrane 19 for monitoring upward and downward expansion change of protective membrane 19 on the reticle R (step S3); closing the chamber door 12 and exhausting air inside the chamber body 10 to form negative pressure inside the chamber body 10 for separating reticle R and contaminants or chemical contaminants on or near reticle R (step S4-1); terminating exhaustion process of air inside the chamber body 10 when the negative pressure or pressure in the chamber body 10 is lower than a pre-set pressure value to maintain negative pressure in stable status inside the chamber body 10 (step S4-2); injecting a gas into the chamber body 10 to gradually change the pressure in the chamber body 10 from status of negative pressure to the initial pressure or close to atmospheric pressure (step S4-3); continuing to inject gas into the chamber body 10 to form positive pressure in the chamber body 10 (step S4-4); opening chamber door 12 and taking out reticle R to complete the cleaning procedure of reticle R (step S5); wherein, when the aforementioned optical component 20 detects that the upward and downward expansion change of protective membrane 19 on reticle R exceeds a pre-set value, air exhaustion or injection process is terminated. This pre-set value is about 1˜4 mm, which means that the protective membrane 19 expands upward or downward for 1˜4 mm, 3 mm or 4 mm being preferred value. And the default pressure value is about 0˜5 mmHg or 0˜5 Torr, wherein 0.5 mmHg or 1 mmHg is the preferred value.

When the aforementioned optical component 20 detects that the change of protective membrane 19 exceeds the pre-set value, it outputs an electric signal to the controller 40, and the controller 40 further outputs another electric signal to terminate air exhaustion or injection. And after waiting for a period, the controller 40 outputs another electric signal to resume the process of air exhaustion or injection. And the function of the step of injecting air to form positive pressure in the chamber body 10 as described above (step S4-4) is to prevent air outside the chamber body 10 or contaminants or chemical contaminants from entering the interior of chamber body 10 in large amount when the chamber door 12 is opened. But in another embodiment, this step of injecting air to form positive pressure in the chamber body 10 (step S4-4) can be omitted, meaning that the reticle can be taken out when the pressure inside the chamber body 10 resumes to the atmospheric pressure. And in still another embodiment, after positive pressure is formed in the chamber body 10 (step S4-4), exhaustion of air inside the chamber body 10 can be resumed to perform the next cycle (step S4-1). Of course, the next cycle (step S4-1) is not limited only to be performed after the positive pressure is formed; when a negative pressure (S4-2) or pressure close to atmospheric pressure maintained in the chamber body 10, the air exhaustion can also be performed.

And the reticle cleaning device 100 used in the above steps at least includes an operation interface 50 which allows the user to input all kinds of commands or parameters to facilitate the operation of the whole process. Furthermore, in order to prevent the chamber door 12 from being accidentally opened by other users when air exhaustion or injection is performed, an opening-proof device can be disposed on the chamber door 12 or the handler 121 of chamber door 12 to further enhance the present invention.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A reticle cleaning device, including:
a chamber body having a sealed chamber in which is disposed with a reticle stage for carrying a reticle, said reticle being disposed with a protective membrane;
an optical component for transmitting a light beam to said protective membrane and receiving light beam reflected from said protective membrane; and
a pump for exhausting air in said sealed chamber to form negative pressure in said sealed chamber in order to separate contaminants on said reticle.

2. A reticle cleaning device, comprising:
a chamber body having a sealed chamber in which is disposed with a reticle stage for carrying a reticle, said reticle including a frame and on said frame being attached with a layer of protective membrane;
an optical component for transmitting a light beam to said protective membrane and receiving light beam reflected from said protective membrane, and for outputting a signal to indicate upward and downward expansion change of said protective membrane on said reticle;
a pump for exhausting air in said sealed chamber of said chamber body to form negative pressure in said sealed chamber in order to separate contaminants on said reticle; and
a controller for receiving said signal of said optical component, said controller outputting another signal to terminate operation of said pump when said signal indicates that upward and downward expansion change of said protective membrane on said reticle is larger than a pre-set value.

3. The reticle cleaning device according to claim 2, wherein said optical component includes a light-transmitter and a light-receiver.

4. The reticle cleaning device according to claim 3, wherein said light beam provided by said light-transmitter is selected from one of the groups consisting of laser light, visible light and infrared light.

5. The reticle cleaning device according to claim 2, wherein said chamber body further includes an opening and a chamber door that closes said opening to facilitate exporting and importing of said reticle.

6. The reticle cleaning device according to claim 2, wherein said sealed chamber of said chamber body further includes a pressure meter to monitor pressure inside said sealed chamber.

7. The reticle cleaning device according to claim 2, wherein said sealed chamber of said chamber body further includes a reticle detector to detect whether said reticle is placed on said reticle stage.

8. The reticle cleaning device according to claim 2, wherein when said pump exhausts air inside said sealed chamber of said chamber body, pressure in said sealed chamber is lower than atmospheric pressure.

9. The reticle cleaning device according to claim 2, wherein said pump can further inject a gas into said sealed chamber of said chamber body to resume pressure in said sealed chamber to atmospheric pressure.

10. The reticle cleaning device according to claim 2, wherein said pump can further inject a gas into said sealed chamber of said chamber body to increase pressure in said sealed chamber to be higher than atmospheric pressure.

11. The reticle cleaning device according to claim 2, wherein when said optical component detects upward and downward expansion change of said protective membrane on said reticle to be larger than 1 mm, operation of said pump is terminated.

12. The reticle cleaning device according to claim 2, wherein when said optical component detects upward and downward expansion change of said protective membrane on said reticle to be larger than 3 mm, said controller output a signal to terminate operation of said pump.

13. A reticle cleaning method, comprising following steps:
providing a reticle inside a chamber body, wherein on said reticle is disposed with a protective membrane;
providing an optical component, said optical component transmitting a light beam to said protective membrane on said reticle and receiving light beam reflected from said protective membrane to monitor upward and downward expansion change of said protective membrane on said reticle;
exhausting air inside said sealed body to form negative pressure in said sealed body in order to separate contaminants on said reticle; wherein, when said optical component detects that upward and downward expansion change of said protective membrane on said reticle is larger than a pre-set value, exhaustion of air inside said sealed body is terminated.

14. The reticle cleaning method according to claim 13, wherein said optical component includes a light-transmitter and a light-receiver.

15. The reticle cleaning method according to claim 13, wherein said chamber body further includes a reticle stage for carrying said reticle.

16. The reticle cleaning method according to claim 15, wherein said chamber body further includes a reticle detector to detect whether said reticle is placed on said reticle stage.

17. The reticle cleaning method according to claim 13, wherein said chamber body further includes a pressure meter to monitor pressure inside said chamber body.

18. The reticle cleaning method according to claim 13, wherein when said pump exhausts air inside said chamber body, pressure in said chamber body is lower than atmospheric pressure.

19. The reticle cleaning method according to claim 13, wherein said pump can further inject a gas into said chamber body to resume pressure in said chamber body to atmospheric pressure.

20. The reticle cleaning method according to claim 13, wherein said pump can further inject a gas into said chamber body to increase pressure in said chamber body to be higher than atmospheric pressure.

21. The reticle cleaning method according to claim 13, wherein when pressure inside said chamber body is lower than a pre-set pressure value, exhaustion of air inside said chamber body is terminated.

22. The reticle cleaning method according to claim 21, wherein said pressure value is 1 mmHg.

23. The reticle cleaning method according to claim 21, wherein said pressure value is 0.5 mmHg.

24. The reticle cleaning method according to claim 13, further including a step for gas injection, wherein a gas can be further injected into said chamber body to resume pressure in said chamber body to atmospheric pressure.

25. The reticle cleaning method according to claim 13, further including a step for gas injection, wherein a gas can be further injected into said chamber body to increase pressure in said chamber body to be higher than atmospheric pressure.
